(19) United States
(12) Patent Application Publication
(10) Pub. No.: US 2022/0371426 A1
(43) Pub. Date: Nov. 24, 2022

(54) TORQUE ROD

(71) Applicant: HONDA MOTOR CO., LTD., Tokyo (JP)

(72) Inventors: Isao OBATA, Saitama (JP); Yuho ITO, Saitama (JP)

(21) Appl. No.: 17/663,668

(22) Filed: May 17, 2022

(30) Foreign Application Priority Data
May 20, 2021 (CN) 202110550531.8

(51) Int. Cl. B60K 5/12

(52) U.S. Cl. CPC B60K 5/1208; B60K 5/1241

(57) ABSTRACT

A torque rod includes a drive side connecting part that is connected to a drive source, a vehicle body side connecting part that is connected to a vehicle body, and a coupling part that couples the drive side connecting part with the vehicle body side connecting part. The drive side connecting part includes a cylindrical cylinder part provided to the coupling part, a plate spring provided within the cylinder part, and an attachment member that attaches to the drive source. The attachment member is connected to the cylinder part via the plate spring elastically deformed by the movement of the attachment member due to vibrations of the drive source.

This application is based on and claims the benefit of priority from Chinese Patent Application No. CN202110550531.8, filed on 20 May 2021, the content of which is incorporated herein by reference.

### BACKGROUND OF THE INVENTION

### Field of the Invention

The present invention relates to a torque rod.

### Related Art

Patent Document 1 below discloses a torque rod that prevents a power train, which integrally couples an engine and a transmission, from tilting in the front-back direction during acceleration or deceleration of an automobile. The torque rod includes an annular first end part connected to a drive source side, an annular second end part connected to a vehicle body side, and a rod-shaped coupling part that integrally couples the first and second end parts. The outer peripheral surface of a first elastic bushing made of rubber is fixed to the inner peripheral surface of the first end part. The outer peripheral surface of a collar is fixed to the inner peripheral surface of the first elastic bushing.

### SUMMARY OF THE INVENTION

The torque rod is tilted so that the second end part connected to the vehicle body side is .located higher than the first end part connected to the drive source side. In this case, a gearbox, which is located behind the power train, cannot be positioned further forward because the second end part is in the way. Therefore, to lower the second end part, the torque rod needs to be positioned more forward than conventional ones to suppress the influence of the twisting that occurs on the torque rod. In other words, the first end part is positioned more forward than conventional ones.

However, the lower surface of the engine to which the first end part is attached is tilted and the minimum ground clearance of the first end part is fixed, and the gap between the lower surface of the engine and the minimum ground clearance decreases in a forward direction, and thus a conventional size first end part cannot be placed in the forward part of the gap. Therefore, it is desirable to reduce in size the first end part connected to the drive source side. When reducing in size the first end part, the radial thickness of the first elastic bushing must be reduced accordingly, but considering the durability of the first elastic bushing including resistance to bent damage, the radial. thickness of the first elastic bushing cannot be reduced.

In response to the above issue, it is an object of the present invention to achieve size reduction of a connecting part connected to a drive source in a torque rod by way of a completely different configuration from conventional ones.

(1) A first aspect of the present invention includes a drive side connecting part that is connected to a drive source, a vehicle body side connecting part that is connected to a vehicle body, and a coupling part that couples the drive side connecting part with the vehicle body side connecting part. The drive side connecting part includes a cylindrical cylinder part provided to the coupling part, a metal plate spring provided within the cylinder part, and an attachment member that attaches to the drive source. The attachment member is connected to the cylinder part via the plate spring.

(2) In a second aspect of the present invention according to the first aspect, the plate spring may be elastically deformable in a front-back direction of the vehicle body.

(3) In a third aspect of the present invention according to the second aspect, the plate spring may include a pair of bent parts formed by bending both end parts of the plate spring in a direction toward each other, and a central part in a length direction of a plate material provided between the of bent parts. The central part may be positioned on a side of the coupling part so that a gap is formed between the central part and an inner peripheral surface of the cylinder part. An outer periphery of the attachment member may be supported by the central part and the pair of bent parts of the plate spring provided within the cylinder part in a state where the attachment member penetrates through the cylinder part in an axial direction of the cylinder part.

(4) In a fourth aspect of the present invention according to the third aspect, in the gap, a protrusion, which protrudes toward the central part of the plate spring, may be formed on the inner peripheral surface of the cylinder part.

(5) In a fifth aspect of the present invention according to the third aspect, a rotation prevention part that prevents the plate spring from rotating around an axis of the cylinder part may be formed on the inner peripheral surface of the cylinder part on a side opposite to the gap with the attachment member interposed between the rotation prevention part and the gap.

(6) In a sixth aspect of the present invention according to the first aspect, the drive side connecting part may include a first cover member that closes an opening on one axial end side of the cylinder part and a second cover member that closes an opening on the other axial end side of the cylinder part. One axial end part of the attachment member may toe exposed by penetrating through the first cover member, and the other axial end part of the attachment member may be exposed toy penetrating through the second cover member.

(7) In a seventh aspect of the present invention according to the first aspect, the drive side connecting part may further include a cylindrical collar member that covers an outer periphery of the attachment member. The attachment member may be supported by the plate spring via the collar member.

According to the present, invention, it is possible to achieve size reduction of a connecting part connected to a drive source in a torque rod by way of a completely different configuration from conventional ones.

### BRIEF DESCRIPTION OF THE DRAWINGS

FIG. 1 is a schematic side view showing the use state of torque rod according to an embodiment of the present invention;

FIG. 2 is a schematic longitudinal sectional view of the main components of the torque rod shown in FIG. 1 in a side view; and

FIG. 3 is a schematic longitudinal sectional view of the torque rod shown in FIG. 1 in a front view.

### DETAILED DESCRIPTION OF THE INVENTION

A specific embodiment of the present invention will now be described in detail with reference to the drawings.

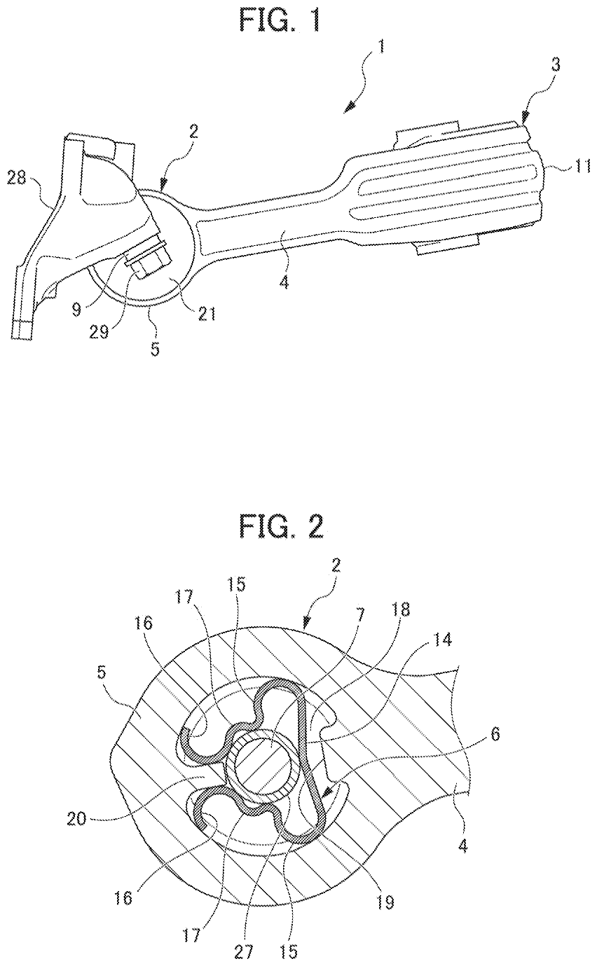

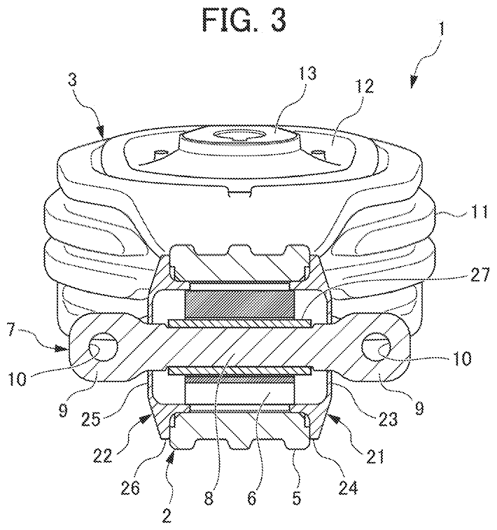

FIGS. 1 to 3 show a torque rod according to an embodiment of the present invention. FIG. 1 is a schematic right side view showing the use state. FIG. 2 is a schematic longitudinal sectional view of the main components in a right side view. FIG. 3 is a schematic longitudinal sectional view in a front view. A torque rod 1 of the present embodiment includes a drive side connecting part 2 connected to a drive source, a vehicle body side connecting part 3 connected to a vehicle body, and a coupling part 4 coupling the drive side connecting part 2 with the vehicle body side connecting part 3, and is applied to an automobile. Although not shown in the drawings, the drive source is an automobile engine.

The drive side connecting part 2 includes a cylindrical cylinder part 5, a plate spring 6 provided within the cylinder part 5, and an attachment member 7 that attaches to the drive source. The cylinder part S is cylindrical with its axis along the left-right direction, and is provided to a coupling part 4 to be described below. The plate spring 6 is formed from an elastically deformable metal plate material. The plate spring 6 is elastically deformable in the front-back direction of the vehicle body (front-back direction of the torque rod 1) within the cylinder part 5, The attachment member 7 is made of metal and includes a rod-shaped rod part 8 and plate-shaped plate parts 9 respectively provided to axial ends of the rod part 8. A through hole 10 is formed to penetrate through the plate part 9 in the thickness direction.

The vehicle body side connecting part 3 has a conventionally known structure. Typically, the. vehicle body side connecting part 3 includes a cylindrical cylinder part 11, an elastic bushing 12 provided within the cylinder part 11, and a collar 13 provided within the cylinder part 11. The cylinder part 11 is cylindrical with its axis along the vertical direction and is provided to the coupling part 4 to be described below. The elastic bushing 12 is made of elastically deformable rubber. The elastic bushing 12 is cylindrical and has an outer peripheral surface fixed to the inner peripheral surface of the cylinder part 11. The collar 13 is cylindrical and has an outer peripheral surface fixed to the inner peripheral surface of the elastic bushing 12.

The coupling part 4 is rod-shaped, and has one axial end to which the cylinder part 5 of the drive side connecting part 2 is provided and the other axial end to which the cylinder part 11 of the vehicle body side connecting part 3 is provided. As shown in FIG. 1, when the torque rod 1 is provided in an automobile, the coupling part 4 is positioned along the front-back direction. In this case, the cylinder part 5 of the drive side connecting part 2 is positioned at the front; end of the coupling part 4, and the cylinder part 11 of the vehicle body side connecting part 3 is positioned at the back end of the coupling part 4. In the present embodiment, the cylinder part 5 of the drive side connecting part 2, the cylinder part 11 of the vehicle body side connecting part 3, and the coupling part 4 are integrally formed.

As shown in FIG. 2, the plate spring 6 has a substantially triangular shape in a side view, in which a pair of bent parts 15, 15 are formed by bending both end parts of the plate spring 6 in a direction toward each other, and a central part 14 in the length direction of the plate material is provided between the pair of bent parts 15, 15. The central part 14 of the plate spring 6 is curved inward in substantially the center. Each of the bent parts 15 of the plate spring 6 includes a folded piece 16 formed by folding back the leading end part. Each of the bent parts 15 of the plate spring 6 includes a corrugated plate part 17 having a corrugated shape in a side view. The corrugated plate part 17 is positioned closer to the base end than the folded piece 16.

A bent part between one bent part 15 and the central part 14, a bent part between the other bent part 15 and the central part 14, and the folded pieces 16, 16 of the pair of bent parts 15, 15 are in contact with the inner peripheral surface of the cylinder part 5, and thereby the plate spring 6 is supported by the cylinder part 5. In this case, the plate spring 6 is provided within the cylinder part 5 with the central part 14 located on the side of the coupling part 4. other words, when the plate spring 6 is provided within the cylinder part 5, the central part 14 is located at the back within the cylinder part 5. When the plate spring 6 is provided within the cylinder part 5, a gap 18 is formed between the central part 14 of the plate spring 6 and the inner peripheral, surface of the cylinder part 5.

In the gap 18 between the central part 14 of the plate spring 6 and the inner peripheral surface of the cylinder part 5, a protrusion 19 that protrudes toward the central part 14 of the plate spring 6 is formed on the inner peripheral surface of the cylinder part 5. The protrusion 19 has a substantially rectangular block shape, and protrudes forward from the back end of the inner peripheral surface of the cylinder part 5. There is a gap between the leading end of the protrusion 19 and the central part 14 of the plate spring 6.

In addition, on the inner peripheral surface of the cylinder part 5, on the side opposite to the side adjacent to the gap 18, a rotation prevention part 20 is formed to prevent the plate spring 6 provided within the cylinder part 5 from rotating around the axis of the cylinder part 5. The rotation prevention part 20 has a substantially rectangular block shape and protrudes backward from the front end of the inner peripheral surface of the cylinder part 5. The rotation prevention part 20 is inserted between the leading end parts of the pair of bent parts 15, 15 of the plate spring 6 provided, within the cylinder part 5.

In case of the present embodiment, the drive side connecting part 2 includes a first cover member 21 that closes the opening on one axial end side of the cylinder part 5, and a second cover member 22 that closes the opening on the other axial end side of the cylinder part 5. The first cover member 21 includes a cylindrical cylinder part 23 that opens only to the left, and a flange part 24 that extends radially outward from the right end of. the cylinder part 23. The second cover member 22 has the same configuration (symmetrical) as the first cover member 21 and includes a cylindrical cylinder part 25 that opens only to the right and a flange part 26 that is provided to the left end of the cylinder part 25. The drive side connecting part 2 further includes a cylindrical collar member 27 that covers the outer periphery of the attachment member 7. The collar member 27 has an elongated cylindrical shape with its axis along the left-right direction, is made of resin, and covers the outer periphery of the rod part 8 of the attachment, member 7.

As shown in FIG. 3, the opening on the right side of the cylinder part 5 is closed by the first cover member 21, and the opening on the left side of the cylinder part 5 is closed by the second cover member 22. The first cover member 21 is fixed by inserting the cylinder part 23 into the opening on the right side of the cylinder part 5 until the flange part 24 abuts against the right surface of the cylinder part 5. The second cover member 22 is fixed by inserting the cylinder part 25 into the opening on the left side of the cylinder part 5 until the flange part 26 abuts against the left surface of the cylinder part 5.

As shown in FIGS. 2 and 3, the attachment member 7 is supported by the plate spring 6 provided within the cylinder part 5 via the collar member 27 in a state of penetrating through the cylinder part 5 in the axial direction of the cylinder part. Specifically, the outer periphery of the rod part 8 of the attachment member 7 is supported by the central part 14 and the adjacent waves of the corrugated plate parts 17 of the pair of bent parts 15, 15 of the plate spring 6 provided within the cylinder part 5 via the collar member 27. One axial end part of the attachment member 7 is exposed by penetrating through a through hole formed in the first cover member 21. Thus, the plate part 9 on the right side of the attachment member 7 is exposed from the first cover member 21. The other, axial end part of the attachment member 7 is exposed by penetrating through a through hole formed in the second cover member 22, Thus, the plate part 9 on the left side of the attachment member 7 is exposed from the second cover member 22.

As shown in FIG. 1, in the present embodiment, the drive side connecting part 2 is connected to the drive source. The drive side connecting part 2 is connected to the drive source via the attachment member 7. The attachment member 7 is attached to a bracket 28 fixed to the drive source. To attach the attachment member 7 to the bracket 28, bolts 29 are screwed into the bracket 28 through the through holes 10 of the plate parts 9 with the plate parts 9 of the attachment member 7 superposed on the bracket 28. In this way, the drive side connecting part 2 is connected to the drive source via the bracket 28. As shown in FIG. 1, when the drive side connecting part 2 is connected to the drive source and the vehicle body side connecting part 3 is connected to the vehicle body, the torque rod 1 is inclined so that the vehicle body side connecting part 3 is positioned higher than the drive side connecting part 2, and the torque rod 1 is positioned along the tangential direction of the engine torque. Although not particularly shown, the connection of the vehicle body side connecting part 3 to the vehicle body can be made by various conventionally known methods.

In the case of the torque rod 1 of the present embodiment, the attachment member 7 that attaches to the drive source is connected to the cylinder part 5 via the plate spring 6. Therefore, the plate spring 6 is elastically deformed by the movement of the attachment member 7 due to vibrations of the drive source, and thereby the vibrations of the drive source can be absorbed. Thus, in the present embodiment, since the plate spring 6, which is more resistant to heat than conventional rubber elastic bushings, is used as an elastic member, the drive side connecting part 2 can be reduced in size by way of a completely different configuration from conventional ones. In the case of the torque rod 1 of the present embodiment, the gap 18 between the central part 14 of the plate spring 6 and the inner peripheral surface of the cylinder part 5 is formed. Therefore, according to the torque rod 1 of the present embodiment, the central part 14 of the plate spring 6 can be elastically deformed in the front-back direction, so that vibrations in the front-back direction due to vibrations of the drive source can be absorbed. In other words, tangential vibrations of engine torque can be absorbed.

In the case of the torque rod 1 of the present embodiment, the protrusion 19 that protrudes toward the central part 14 of the plate spring 6 is formed on the inner peripheral surface of the cylinder part 5 on the coupling part 4 side. This enables the maximum elastic deformation quantity of the central part 14 of the plate spring 6 to be regulated, and thus it is possible to obtain the effects of obtaining non-linear spring rate characteristics and relieving the maximum stress of the plate spring 6. In the case of the torque rod 1 of the present embodiment, since the rotation prevention part 20 is formed on the inner peripheral surface of the cylinder part 5, the plate spring 6 can be prevented from rotating around the axis of the cylinder part 5. Moreover, in the case of the torque rod 1 of the present embodiment, since the rotation prevention part 20 is formed on the inner peripheral surface of the cylinder part 5 on the side opposite to the gap 18 with the attachment member 7 interposed between the rotation prevention part 20 and the gap 18, the influence of elastic deformation of the plate spring 6 can be minimized and the effect, of preventing rotation of the plate spring 6 can be enhanced.

In the case of the torque rod 1 of the present embodiment, the first cover member 21 closes the opening on one axial and side of the cylinder part 5, and the second cover member 22 closes the opening on the other axial end side of the cylinder part 5. Therefore, the plate spring 6 can be prevented from being exposed to water, and thus rusting of the plate spring 6 can be suppressed. Further, in the case of the torque rod 1 of the present embodiment, the attachment member 7 is supported by the plate spring 6 via the collar member 27. Therefore, the metal contact between the attachment member 7 and the plate spring 6 can be prevented, sliding resistance between the attachment member 7 and the plate spring 6 can be reduced, and thereby abnormal noise can be prevented and noise, vibration, and harshness (NVH) can be ensured.

The present invention is not limited to the above embodiment, and modifications and improvements are included in the present invention to the extent that the object of the invention can be achieved.

For example, in the above embodiment, the plate spring 6 is substantially triangular in a side view, but the shape of the plate spring 6 is not limited to this and can be changed to any appropriate shape.

### EXPLANATION OF REFERENCE NUMERALS

1 torque rod
2 drive side connecting part
3 vehicle body side connecting part
4 coupling part
5 cylinder part
6 plate spring
7 attachment member
14 central part
15 bent part
18 gap
19 protrusion
20 rotation prevention part
21 first cover member
22 second cover member
27 collar member

What is claimed is:

1. A torque rod, comprising:
a drive side connecting part that is connected to a drive source;
a vehicle body side connecting part that is connected to a vehicle body; and
a coupling part that couples the drive side connecting part with the vehicle body side connecting part,
the drive side connecting part comprising a cylindrical cylinder part provided to the coupling part, a metal plate spring provided within the cylinder part, and an attachment member that attaches to the drive source, and
the attachment member being connected to the cylinder part via the plate spring.

2. The torque rod according to claim 1, wherein the plate spring is elastically deformable in a front-back direction of the vehicle body.

3. The torque rod according to claim 2,
wherein the plate spring comprises a pair of bent parts formed by bending both end parts of the plate spring in a direction toward each other, and a central part in a length direction of a plate material provided between the pair of bent parts, the central part being positioned on a side of the coupling part so that a gap is formed between the central part and an inner peripheral surface of the cylinder part, and
wherein an outer periphery of the attachment member is supported by the central part and the pair of bent parts of the plate spring provided within the cylinder part in a state where the attachment member penetrates through the cylinder part in an axial direction of the cylinder part.

4. The torque rod according to claim 3, wherein in the gap, a protrusion, which protrudes toward the central part of the plate spring, is formed on the inner peripheral surface of the cylinder part.

5. The torque rod according to claim 3, wherein a rotation prevention part that prevents the plate spring from rotating around an axis of the cylinder part is formed on the inner peripheral surface of the cylinder part on a side opposite to the gap with the attachment member interposed between the rotation prevention part and the gap.

6. The torque rod according to claim 1,
wherein the drive side connecting part comprises a first cover member that closes an opening on one axial end side of the cylinder part, and a second cover member that closes an opening on the other axial end side of the cylinder part, and
wherein one axial end part of the attachment member is exposed by penetrating through the first cover member, and the other axial end part of the attachment member is exposed by penetrating through the second cover member.

7. The torque rod according to claim 1,
wherein the drive side connecting part further comprises a cylindrical collar member that covers an outer periphery of the attachment member, and
wherein the attachment member is supported by the plate spring via the collar member.
